(19) United States
(12) Patent Application Publication
(10) Pub. No.: US 2021/0190460 A1
(43) Pub. Date: Jun. 24, 2021

(54) UNIDIRECTIONAL BALLISTIC GLASS FOR DEFENDING AGAINST SIMULTANEOUS MULTI-SHOT ATTACK

(71) Applicant: SE BEN LLC, Woodinville, WA (US)

(72) Inventor: Javier Moya Gamboa, Bogota (CO)

(73) Assignee: SE BEN LLC, Woodinville, WA (US)

(21) Appl. No.: 17/057,596

(22) PCT Filed: May 17, 2019
(86) PCT No.: PCT/US2019/032975

§ 371 Date: Nov. 20, 2020

Related U.S. Application Data
(60) Provisional application No. 62/673,984, filed on May 20, 2018.

(51) Int. Cl. F41H 5/04; B32B 15/18; B32B 15/04; B32B 17/10

(52) U.S. Cl. CPC F41H 5/0407; B32B 15/18; B32B 15/04; B32B 17/10045; B32B 17/10366; B32B 17/10752; B32B 2307/558; B32B 17/1077; B32B 2255/10; B32B 2255/26; B32B 2266/0278; B32B 2307/584; B32B 2307/73; B32B 17/10761

(57) ABSTRACT

Unidirectional ballistic glasses and methods for manufacturing the same are described herein. The unidirectional ballistic glasses, among other things, may be less susceptible to delamination resulting in greater overall life cycle and may be lighter than conventional unidirectional ballistic glasses. A unidirectional ballistic glass may include, among other things, a plurality of glass sheets that are attached to each other by one or more adhesive intermediate layers where the unidirectional ballistic glass has an exterior side and an interior side opposite from the exterior side, and the plurality of glass sheets includes an exterior glass sheet that is, among the plurality of glass sheets, nearest to or at the exterior side of the unidirectional ballistic glass, and an interior glass sheet that is, among the plurality of glass sheets, nearest to the interior side of the unidirectional ballistic glass. The unidirectional ballistic glass may further include a hydrophobic polymer layer disposed between a polycarbonate layer and the interior glass sheet, and a polyurethane layer and a polyvinyl chloride (PVC) layer that are disposed on peripheral edges of at least the interior glass sheet and the polycarbonate layer.

### CROSS-REFERENCE TO RELATED CASES

This application claims priority to and incorporates by reference international application number PCT/US2019/032975, filed on May 17, 2019, which application claims the benefit of and incorporates by reference U.S. Provisional Patent Application Ser. No. 62/673,984, filed on May 20, 2018, all which applications are incorporated herein by this reference.

### TECHNICAL FIELD

The present disclosure related to safety shields, and more particularly, to ballistic glasses and methods for making the same.

### BACKGROUND

### Related Art

U.S. Pat. Nos. 9,945,641, 6,276,100, and 4,663,228, and German Patent no. DE 69 42 9559 show example prior bullet resistant glasses, which are helpful for providing context for understanding the present disclosure, all of which are incorporated herein by reference in their entireties.

Ballistic glasses are used to protect people in vehicles, such as ground assault vehicles, personnel transportation, railcars, aircraft, among others, as well as buildings and other structures, such as houses, buildings, bunkers, and so forth, from ballistics. Ballistics may include, for example, projectiles such as bullets, shrapnel and/or waves generated by nearby explosions, among others.

Ballistic glasses are commonly laminated, and typically include multiple layers or sheets of glass, plastic, resin, and/or other hard or resilient/elastic materials. When a ballistic projectile hits a ballistic glass, the plate (e.g., a glass sheet) of the ballistic glass exposed to the impact must withstand the perforation by the ballistic projectile, while the opposite side plate (e.g., a resilient layer such as a polymer layer) should stop the projected back fragments of the exposed plate from penetrating completely through the ballistic glass. For example, most ballistic glass can be characterized as having an exterior side (the side of the ballistic glass that will be exposed to ballistic projectiles when used in, for example, armored vehicles), and an interior side (the side of the ballistic glass that will be facing, for example, a cockpit or passenger cabin of a plane or ground vehicle). In the case of unidirectional ballistic glass (e.g., one-way bullet proof glass that stops ballistic projectiles from penetrating through the glass from one direction but does not permit penetration from the opposite direction).

One conventional ballistic glass able to meet the previous precept includes a laminated glass that comprises three 6 mm sheets of silicate glass that are joined together by polyvinyl butyral layers, each layer having a thickness of 0.76 mm. At the interior side of such a ballistic glass is a layer of polycarbonate that is attached to the interior most glass sheet by a layer of thermoplastic polyurethane. However, thermoplastic polyurethane is a material that is relatively difficult to manufacture and, therefore, expensive, so that increases the overall production costs of the ballistic glass that incorporates such material. Further, laminated glass with plastic layers presents difficulties when temperature changes, in which there is a different thermal expansion between a glass layer and, for example, a polycarbonate layer, which leads to deformations, resulting even in the delamination of the ballistic glass. The delamination of the ballistic glass may be caused by different factors. For example, as alluded to above, one cause is as a result of different thermal expansion rates between the glass layer and polycarbonate. Other causes may include, for example, thermal changes, application of external forces such as ballistic projectiles, penetration of water between the various layers of a ballistic glasses, and so forth, that may result in the reduction in the life cycle of the ballistic glass.

To address the delamination problem of ballistic glasses, other materials have been incorporated into ballistic glasses to prevent the delamination of ballistic glasses and to improve adhesion between glass and polycarbonate. For example, in order to address this problem, U.S. Pat. No. 4,663,228 discloses a ballistic glass that incorporates an ionomer resin instead of a thermoplastic polyurethane film into the ballistic glass. The ballistic glass includes different layers of silicate glass sheet and polycarbonate, where the polycarbonate is adhered to a silicate glass sheet by a layer of ionomer resin. However, such a solution does not eliminate delamination problems due to temperature changes.

To solve this problem, German patent no. DE 69 42 9559 discloses an armored glass, particularly for automobiles, that consists of several sheets of silicate glass joined together by intermediate layers of thermoplastic polymer and a sheet of shock-resistant plastic material that is applied with the help of a layer of thermoplastic adhesive on the interior side of the ballistic glass (e.g., the side of the ballistic glass that faces or will face the space, such as a cockpit or passenger cabin, to be protected). To reduce delamination of a ballistic glass, a reflective layer is placed on the outermost glass sheet (e.g., the glass sheet on the exterior side of the ballistic glass) of the ballistic glass, so that thermal radiation that is exposed to the outermost glass sheet is projected outward, protecting the internal layers of the laminated ballistic glass. However, this type of ballistic glass does not offer protection against delamination by the application of external forces.

In addition, many existing ballistic glasses have problems of optical quality, since they present wide distortion, having average optical quality of 80%, in these existing ballistic glasses.

### BRIEF SUMMARY

In various embodiments, a unidirectional ballistic glass for defending against multi-shot attack is provided. The unidirectional ballistic glass may include an exterior side and an interior side opposite from the exterior side, a plurality of glass sheets attached to each other by one or more adhesive intermediate layers, the plurality of glass sheets including an exterior glass sheet that is, among the plurality of glass sheets, nearest to or at the exterior side of the unidirectional ballistic glass, and an interior glass sheet that is, among the plurality of glass sheets, nearest to the interior side of the unidirectional ballistic glass. The unidirectional ballistic glass may also include a hydrophobic polymer layer that is disposed between a polycarbonate layer and the interior glass sheet.

Additionally, the unidirectional ballistic glass may further include a polyurethane layer and a polyvinyl chloride (PVC) layer that are disposed on peripheral edges of at least the interior glass sheet and the polycarbonate layer.

In some embodiments, the one or more adhesive intermediate layers may include a mixture of an ionomer monomer and a hydrophobic polymer.

In some embodiments, the one or more adhesive intermediate layers may include a thermoplastic material that includes at least one of polyvinyl butyral, polyvinyl acetal, polyurethane, or a combination thereof.

In some embodiments, the one or more adhesive intermediate layers may include an ionomer monomer and a material selected from one of polyvinyl butyral, polyvinyl acetal, or polyurethane.

In some embodiments, the plurality of glass sheets may include one or more glass sheets that include at least one of floated glass, borosilicate glass, sodium-calcium glass, lead glass, silica glass, or painting glass.

In some embodiments, the plurality of glass sheets may include a middle glass sheet disposed between the exterior glass sheet and the interior glass sheet, the middle glass sheet being attached to the exterior glass sheet and the interior glass sheet with adhesive intermediate layers.

In some embodiments, the polyurethane layer and the PVC layer may be further disposed on peripheral edges of at least the exterior glass sheet and the middle glass sheet.

In some embodiments, the unidirectional ballistic glass may further comprise a ballistic steel layer disposed along peripheral edge or edges of the middle glass sheet.

In some embodiments, the ballistic steel layer may be attached to the exterior glass sheet and the interior glass sheet with the adhesive intermediate layers.

In some embodiments, the adhesive intermediate layers may be comprised of polyurethane or ionomer monomer.

In some embodiments, an anti-scratch film may be disposed on a surface of the polycarbonate layer that is opposite from another surface of the polycarbonate layer that faces the hydrophobic polymer layer.

In some embodiments, the anti-scratch film may be attached to the polycarbonate layer by an intermediate layer of thermoplastic.

In some embodiments, the polyurethane layer may be disposed on the peripheral edges of the interior glass sheet and the polycarbonate layer, and the PVC layer may be disposed on a top side of the polyurethane layer opposite from a side of the polyurethane layer that is attached to the peripheral edges of the interior glass sheet and the polycarbonate layer.

In various embodiments, a unidirectional ballistic glass is provided that includes, among other things, an exterior side and an interior side opposite from the exterior side, a plurality of glass sheets attached to each other by adhesive intermediate layers, the plurality of glass sheets including an exterior glass sheet that is, among the plurality of glass sheets, nearest to or at the exterior side of the unidirectional ballistic glass and an interior glass sheet that is, among the plurality of glass sheets, nearest to the interior side of the unidirectional ballistic glass, and a middle glass sheet disposed between the exterior glass sheet and the interior glass sheet. The unidirectional ballistic glass may also include a ballistic steel layer that is disposed along peripheral edge or edges of the middle glass sheet and attached to the exterior glass sheet and the interior glass sheet by the adhesive intermediate layers. The unidirectional ballistic glass may additionally include a hydrophobic polymer layer that is disposed between a polycarbonate layer and the interior glass sheet.

In some embodiments, the adhesive intermediate layers may include a mixture of an ionomer monomer and a hydrophobic polymer.

In some embodiments, the unidirectional ballistic glass may further include a polyurethane layer and a polyvinyl chloride (PVC) layer that are disposed on peripheral edges of at least the interior glass sheet and the polycarbonate layer.

In some embodiments, the polyurethane layer and the PVC layer are disposed on peripheral edges of each of the ballistic steel layer, the middle glass sheet, and the exterior glass sheet.

In some embodiments, the polyurethane layer may be disposed on the peripheral edges of the interior glass sheet and the polycarbonate layer, and the PVC layer may be disposed on a top side of the polyurethane layer opposite from a side of the polyurethane layer that is attached to the peripheral edges of the interior glass sheet and the polycarbonate layer.

In some embodiments, the polyurethane layer and the PVC layer may be disposed on the peripheral edges of the ballistic steel layer and the exterior glass sheet.

In some embodiments, the adhesive intermediate layers may include a thermoplastic material that includes at least one of polyvinyl butyral, polyvinyl acetal, polyurethane, or a combination thereof.

In various embodiments, a method for manufacturing a unidirectional ballistic glass is provided herein. The method includes preparing unidirectional ballistic glass components for assembly including cutting glass sheets to be incorporated into the unidirectional ballistic glass according to required shape for its intended purpose, cutting a polycarbonate layer according to the required shape, bending the glass sheets, trimming of the glass sheets, and polishing the glass sheets.

The method may further include assembling, to produce a ballistic package, the unidirectional ballistic glass components in a particular order and orientation corresponding to the order and orientation that the unidirectional ballistic glass components will be in when unidirectional ballistic glass is produced, the assembly and arrangement includes: stacking together two or more glass sheets with one or more adhesive intermediate layers placed between the glass sheets, where one of the glass sheets is an exterior glass sheet and another one of the glass sheets is an interior glass sheet, the unidirectional ballistic glass to be produced having an interior side and an exterior side, the exterior glass sheet will be, among the glass sheets, nearest to or at the exterior side of the unidirectional glass sheet to be produced, and the interior glass sheet will be, among the glass sheets, nearest to interior side of the unidirectional glass sheet; placing between the interior glass sheet and a polycarbonate layer is a hydrophobic polymer layer; and disposing on the peripheral edges of at least the interior glass sheet, the polycarbonate layer, and the hydrophobic polymer layer, a polyurethane layer and a polyvinyl chloride (PVC) layer.

The method may also include subjecting the assembled ballistic package to elevated pressure and temperature and finishing the ballistic package by verifying functionality of the ballistic package, removing burrs from the ballistic page, and polishing edges of the ballistic package.

In some embodiments, the two or more glass sheets include a middle glass sheet that is disposed between the exterior glass sheet and the interior glass sheet, and the one or more adhesive intermediate layers includes an adhesive intermediate layer disposed between the middle glass sheet and the exterior glass sheet and another adhesive intermediate layer disposed between the middle glass sheet and the interior glass sheet.

In some embodiments, the method may further comprise disposing ballistic layer along the peripheral edge or edges of the middle glass sheet.

### BRIEF DESCRIPTION OF THE DRAWINGS

FIG. 1. shows a cross-sectional view of a unidirectional ballistic glass according to some embodiments.

FIG. 2A shows a cross-sectional view of another unidirectional ballistic glass according to some embodiments.

FIG. 2B shows another cross-sectional view of the unidirectional ballistic glass of FIG. 2A.

FIG. 3 shows a cross-sectional view of another unidirectional ballistic glass according to some embodiments.

FIG. 4 shows a high-level process for manufacturing a unidirectional ballistic glass according to some embodiments.

FIGS. 5A and 5B show a process for manufacturing a unidirectional ballistic glass according to some embodiments.

FIG. 6 shows an image showing high optical appearance of a unidirectional ballistic glass according to some embodiments.

FIG. 7 shows an image of how a unidirectional ballistic glass sample limits the impact of a bullet.

FIG. 8A shows an image of an area of a unidirectional ballistic glass impacted by multiple bullets.

FIG. 8B shows an image of an area of a unidirectional ballistic glass impacted by multiple bullets.

FIG. 9A shows an image of an interior side of a unidirectional ballistic glass after a bullet is shot into the interior side from the interior space and penetrating through the unidirectional ballistic glass.

FIG. 9B shows an image of a unidirectional ballistic glass that successfully stopped multiple ballistic projectiles.

FIG. 9C shows an image of a unidirectional ballistic glass that successfully stopped multiple ballistic projectiles.

### DETAILED DESCRIPTION

In the following description, certain specific details are set forth in order to provide a thorough understanding of various embodiments of the disclosure. However, upon reviewing this disclosure one skilled in the art will understand that the disclosure may be practiced without many of these details. In other instances, some well-known structures and materials of construction have not been described in detail to avoid unnecessarily obscuring the descriptions of the embodiments of the disclosure.

In the present description, inasmuch as the terms “about,” “substantially,” “approximately,” and “consisting essentially of” are used, they mean±20% of the indicated range, value, or structure, unless otherwise indicated. It should be understood that the terms “a” and “an” as used herein refer to “one or more” of the enumerated components. The use of the alternative (e.g., “or”) should be understood to mean either one, both, or any combination thereof of the alternatives, unless expressly indicated otherwise. As used herein, the terms “include” and “comprise” are used synonymously, both of which are intended to be construed in a non-limiting sense, as are variants thereof, unless otherwise expressly stated.

Embodiments of the present disclosure are directed to unidirectional ballistic protection glasses (hereinafter “unidirectional ballistic glasses”) that are less susceptible to delamination resulting in a greater overall life cycle and that is lighter than conventional unidirectional ballistic glasses. Unidirectional ballistic glasses offer ballistic protection from one direction, but do not stop a ballistic projectile from penetrating through the glass from the opposite direction. For example, when used as a window for an armored vehicle, the unidirectional ballistic glasses will provide ballistic protection from the external environment, and yet, permit ballistic projectiles, such as bullets, to pass through from the inside of the vehicle.

According to various embodiments, unidirectional ballistic glasses are provided that have a greater life cycle than conventional ballistic glasses (e.g., bulletproof glasses) since they are not subjected to the delamination phenomenon. That is, because the ballistic package of the unidirectional ballistic glasses is not compact (e.g., that at least a polycarbonate layer is not rigidly bonded to a glass sheet along their faces, but instead, are attached to each other along the peripheral edges of the glass sheet and the polycarbonate layer), they are resistant to delamination and are further resistant to multiple simultaneous impacts. An additional benefit of the unidirectional ballistic glasses in accordance with embodiments of the present disclosure is that they are lighter than conventional ballistic glasses since lighter materials may be used to form the unidirectional ballistic glasses and less materials may be used to provide same level of ballistic protection. Likewise, embodiments of the present disclosure are directed to a method of manufacturing the ballistic protection glass according to various embodiments, which may result in producing ballistic glasses with superior optical to quality of up to 100%.

In various embodiments, the unidirectional ballistic glasses may be for simultaneous multi-impact defense and attack that comprise one or more ballistic packages, as well as the method for manufacturing the same. The ballistic packages may comprise layers or sheets of selected materials of glass, ballistic steel, painting glass, polycarbonate, polyvinyl butyral, polyurethane, monomer ionized, among others; where the layer between glass and polycarbonate includes a hydrophobic polymer; and where the edge seal of unidirectional ballistic glass is covered by polyurethane and polyvinyl chloride; which may give the ballistic glass spring properties. By providing spring characteristics, greater protection may be achieved with less material and may extend the overall life cycle of the unidirectional ballistic glass.

The method for manufacturing the ballistic protection glass according to various embodiments of the present disclosure may comprise cutting and enlistment of the materials, the pre-laminating of the materials, the lamination of the materials, the bagging, heat treatment and finishing of the laminated materials, among others.

In various embodiments, the unidirectional ballistic glasses may comprise one or more ballistic packages, where the ballistic packages include layers or sheets of selected materials of glass, ballistic steel, painting glass, polycarbonate, polyvinyl butyral, polyurethane, monomer ionized, among others. The bonding between glasses may be made with high adhesion polymers such as ionomer monomer mixed with a hydrophobic polymer (e.g., a mixture of a ionomer monomer and a hydrophobic polymer) and in the case of joining with ballistic steel, monomer ionomer or polyurethane may be used for this joining as this joining should always remain during the lifecycle of the unidirectional ballistic glass, as well as being able to withstand multiple ballistic impacts in the same area of the unidirectional ballistic glass.

In the case of one of the glass sheets of the unidirectional ballistic glass joining with a polycarbonate layer, a hydrophobic polymer layer may be disposed between the face of the polycarbonate layer and face of an adjacent glass sheet, where at least the peripheral edges of the polycarbonate layer and the adjacent glass sheet are covered by polyurethane and polyvinyl chloride (PVC) layers. By placing a hydrophobic polymer layer between the face of the polycarbonate layer and the face of the adjacent glass sheet, the face of the polycarbonate layer is decoupled from the face of the adjacent glass sheet. However, by disposing the polyurethane and PVC layers along the peripheral edges of the polycarbonate layer and the adjacent glass sheet, the polycarbonate layer is still affixed or attached to the adjacent glass sheet. The combination of these two features ensures that the polycarbonate layer will have spring characteristics. Note that in some embodiments where the unidirectional ballistic glass comprises multiple glass sheets, hydrophobic polymer mixtures may be disposed between the glass sheets, and the polyurethane and PVC layers may be disposed on the peripheral edges of all of the glass sheets as well as the peripheral edge or edges of the polycarbonate layer as will be further described herein. In some embodiments, the polyurethane and/or PVC layers can be substituted or supplemented with other materials of adhesive substance and/or materials for structural support, as may be appreciated by those of ordinary skill in the art after reviewing this disclosure.

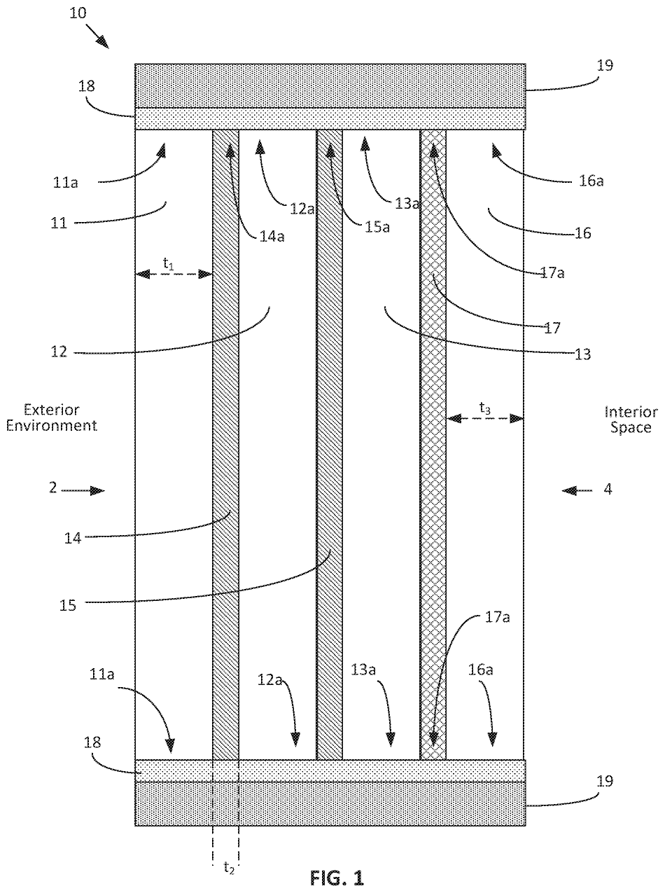

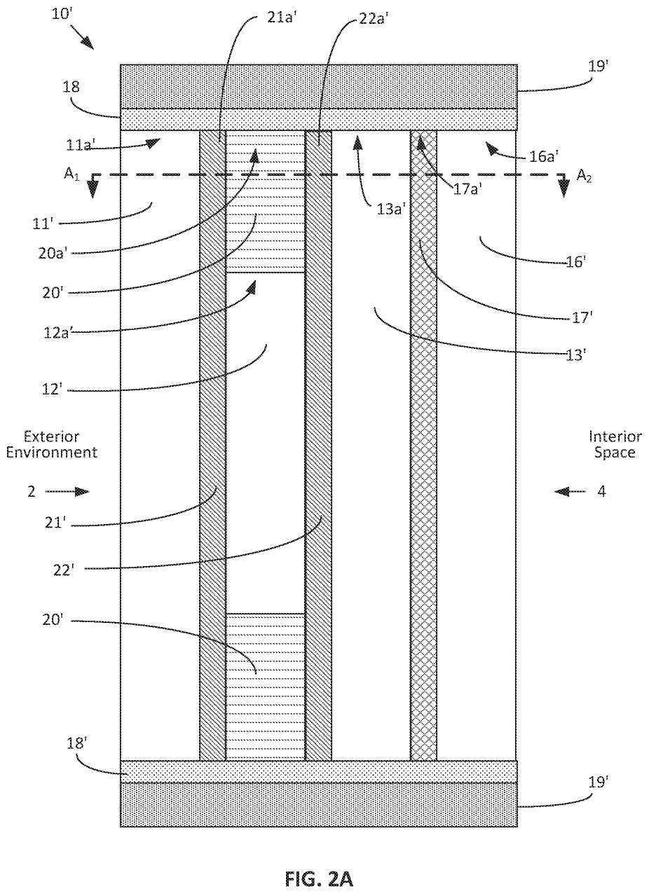

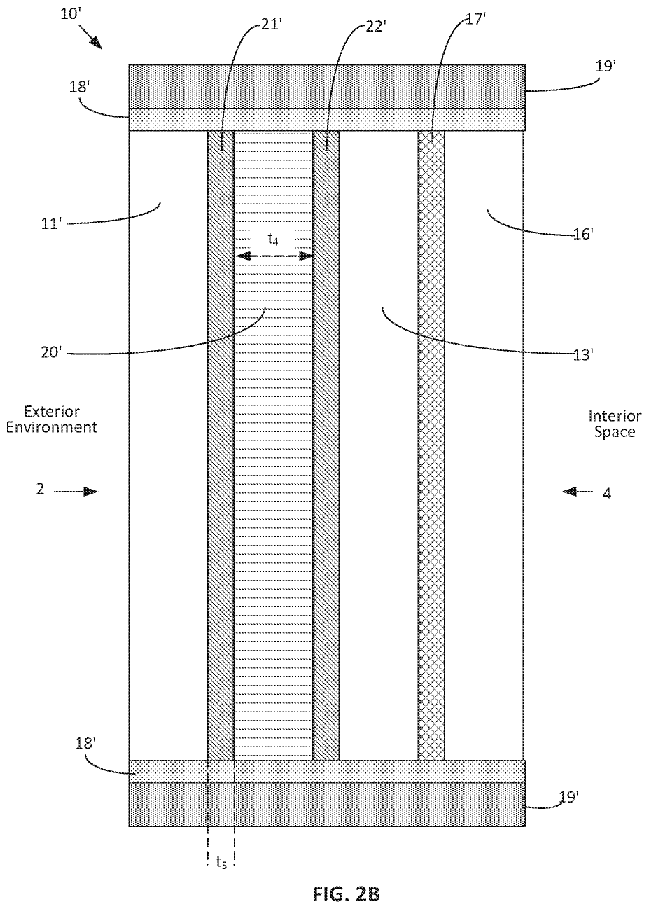

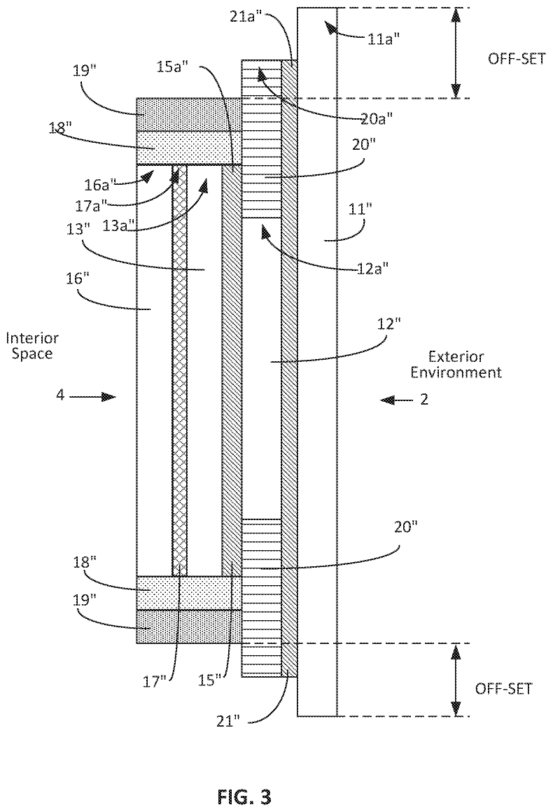

Turning to FIG. 1, which is a cross-sectional view of a unidirectional ballistic glass in accordance with various embodiments of the present disclosure. Note that the unidirectional ballistic glass 10 illustrated in FIG. 1, as well as the unidirectional ballistic glasses 10′ and 10″ of FIGS. 2A, 2B, and 3, are not drawn to scale, and have been simplified for ease of illustration and explanation. The unidirectional ballistic glass 10 having an exterior side 2 (e.g., the side of the unidirectional ballistic glass that will be facing external environment when the unidirectional ballistic glass is employed as a window or windshield for, for example, an armored vehicle) and an interior side 4 (e.g., the side of the unidirectional ballistic glass that will be facing the internal space, such as a cockpit or passenger cabin when the unidirectional ballistic glass is employed as a window or windshield for, for example, an armored vehicle) that is located opposite from the exterior side 2.

In various embodiments, the unidirectional ballistic glass 10 includes three glass sheets 11, 12, and 13 (hereinafter glass sheets 11, 12, and 13), each with a peripheral edge 11 a, 12a, and 13a. Note that in some alternative embodiments, glass sheet 12 may be omitted and there may only be two glass sheets 11 and 13. In still other embodiments, the unidirectional ballistic glass 10 may have more than three glass sheets. In fact, although each of the unidirectional ballistic glasses 10′ and 10″ in FIGS. 2A, 2B, and 3 are illustrated as having three glass sheets; in alternative embodiments, they may actually have fewer or more than three glass sheets. Note that in the following, glass sheet 11 may be referred to as an exterior glass sheet since it is, among the three glass sheets, nearest to or at the exterior side 2 of the unidirectional ballistic glass 10 while glass sheet 13 may be referred to as an interior glass sheet since it is, among the three glass sheets, nearest to the interior side 4 of the unidirectional ballistic glass 10. Glass sheet 12, on the other hand, may be referred to as a middle glass sheet since it is disposed between the exterior glass sheet (e.g., glass sheet 11) and the interior glass sheet (e.g., glass sheet 13).

In some embodiments, the three glass sheets 11, 12, and 13 may be silicate glass, each of which may have a thickness (t1) of between, for example, 4 mm and 10 mm, or about 4 mm and 10 mm. In some embodiments, the three glass sheets 11, 12, and 13 may include at least one of floated glass, borosilicate glass, sodium-calcium glass, lead glass, silicate glass, or painting glass. The glass sheets 11, 12, and 13 may be bonded or affixed together by adhesive intermediate layers 14 and 15. The adhesive intermediate layers 14 and 15 may comprise of one or more thermoplastic materials, each intermediate layer 14 and 15 may have a thickness (t2) of between, for example, 0.00015 mm and 7.6 mm, or about 0.00015 mm and 7.6 mm. In various embodiments, the one or more thermoplastic materials that may be included in the adhesive intermediate layers 14 and 15 may comprise of polyvinyl butyral, polyvinyl acetal, polyurethane, monomer ionized, among others and mixtures thereof. In some embodiments, adhesive intermediate layers 14 and 15 may include an ionomer monomer and a material selected from one of polyvinyl butyral, polyvinyl acetal, or polyurethane. Note that throughout the following description, the terms monomer ionized, ionomer resin, ionomer monomer, and monomer ionomer may be used interchangeably, and are therefore, referring to the same material unless indicate otherwise. An example of an ionomer monomer that may be employed is an ionomer monomer sold under the commercial name of NOVIFLEX sold by AGP PLASTIC.

Disposed at the interior side 4 of the unidirectional ballistic glass 10 is a polycarbonate layer 16. In some embodiments, the polycarbonate layer 16 may have a thickness (t3) of between, for example, 3 mm and 8 mm, or about 3 mm and 8 mm.

Although not explicitly illustrated, in some embodiments, the polycarbonate layer 16 may be coated, for example, on its interior side (e.g., the surface of the polycarbonate layer 16 that will be facing an interior space when the unidirectional ballistic glass 10 is installed as, for example, a window of an armored vehicle) by an anti-scratch film. That is, an anti-scratch film may be disposed on a surface of the polycarbonate layer (e.g., a surface that faces the interior space) that is opposite from another surface of the polycarbonate layer that faces the hydrophobic polymer layer.

In some embodiments, the anti-scratch film may be attached to the polycarbonate layer by an intermediate layer of a thermoplastic material. In some embodiments, the anti-scratch film may be selected from closed-cell polyisocyanurate foam (commercially available under the brand name SECURESHIELD POLYSO sold by CARLISLE SYNTEC SYSTEMS) and polyethylene terephthalate (PET), where the layer of closed-cell polyisocyanurate foam includes PET.

In some embodiments, a hydrophobic polymer layer 17 is disposed between the polycarbonate layer 16 and the glass sheet 13. The hydrophobic polymer layer 17 may permit the separation of the polycarbonate layer 16 from the glass sheet 13 when, for example, a ballistic projectile impacts the bidirectional ballistic glass 10. An example of a hydrophobic polymer, or substance comprising such, that may be used herein is sold under the commercial name of ULTRA EVER DRY sold by ULTRATECH INTERNATIONAL INC.

The peripheral edges 11a, 12a, and 13a of the glass sheets 11, 12, and 13 and the peripheral edges 14a, 15a, 16a, and 17a of the various other layers (e.g., adhesive intermediate layers 14 and 15, the polycarbonate layer 16, and the hydrophobic polymer layer 17), as illustrated, may be covered by a polyurethane layer 18 and a polyvinyl chloride (PVC) layer 19, where the polyurethane layer 18 is disposed on the peripheral edges 11a, 12a, and 13a, 14a, and 15a, 16a, and 17a of the glass sheets 11, 12, and 13, the adhesive intermediate layers 14 and 15, the polycarbonate layer 16, and the hydrophobic polymer layer 17, and the PVC layer 19 is disposed on top side of the polyurethane layer 18 opposite from a side of the polyurethane layer 18 that is attached to the peripheral edges 11a, 12a, and 13a, 14a, and 15a, 16a, and 17a of the glass sheets 11, 12, and 13, adhesive the intermediate layers 14 and 15, the polycarbonate layer 16, and the hydrophobic polymer layer 17. The polyurethane layer 16 and the PVC layer 17, in addition to preventing entry of water into the various layers and sheets of the unidirectional ballistic glass 10, allows the mooring of its layers and together with the hydrophobic polymer layer 17 and the polycarbonate layer 16 which acts as a spring that allows a greater number of ballistic projectile impacts without permitting complete penetration of the ballistic projectiles.

That is, when the polycarbonate layer 16 exhibits spring characteristics, such spring characteristics allow for a better distribution of kinetic energy when a ballistic projectile impacts the unidirectional ballistic glass 10. When the ballistic projectile hits the unidirectional ballistic glass 10 on the external side 2 of the unidirectional ballistic glass 10, the ballistic projectile generates an impact that destroys, for example, the outer glass sheet 11, where the ballistic projectile finds resistance due the hardness of the glass sheet 11 and resulting in an inelastic hit. The kinetic energy of the ballistic projectile is then transmitted through the mass of the unidirectional ballistic glass 10.

As the ballistic projectile is trying to penetrate through the various glass sheets 11, 12, and 13 (e.g., floated glasses), the ballistic projectile is flatten and/or breaks apart, and the velocity and the kinetic energy of the ballistic projectile drops to zero or near zero allowing the last sheets or layers (e.g., polycarbonate layer 16) of the unidirectional ballistic glass 10 to completely stop the ballistic projectile (or fragments of the ballistic projectile and/or fragments of the glass sheets 11, 12, and 14) from penetrating completely through unidirectional ballistic glass 10 and breaking out of the interior side 4 of the unidirectional ballistic glass 10.

Note that as the ballistic projectile is burrowing through the different glass sheets and the various polymer layers, kinetic energy is being transmitted through the mass of the unidirectional ballistic glass 10, so that, when the ballistic projectile finally reaches the polycarbonate layer 16, the combination of the polycarbonate layer 16 (with a very high elastic limit that is separated from the glass sheet 13 by the hydrophobic polymer layer 16) and the peripheral edges of the polycarbonate layer 16 being tied or attached to a high density adhesive (e.g., polyurethane 18 and PVC 19) resulting in a spring-like effect and causing whatever remaining kinetic energy that the ballistic projectile has left to be dispersed around the area of the polycarbonate layer 16 that the ballistic projectile impacts. Upon impact, this impact area of the polycarbonate layer 16 will detach from glass sheet 13. However, because of the high elastic characteristics of the polycarbonate layer 16, the impact area will “spring” back and return to its original position. Because this combination of the polycarbonate layer 16, the hydrophobic polymer layer 17, and the polyurethane 18 and the PVC 19 layers disposed on the peripheral edges, a spring effect is provided that has its own elastic limit, parallel to the glass mass capacity to reduce the kinetic energy of the ballistic projectile and the strength of the impact. As a result, the unidirectional ballistic glass 10 can continue receiving ballistic projectile impacts without allowing the ballistic projectiles from penetrating completely through the unidirectional ballistic glass 10.

When a ballistic projectile is shot into the exterior side 2 of the unidirectional ballistic glass 10 from the exterior environment, the hydrophobic polymer layer 17 that is located between the glass sheet 13 and the polycarbonate layer 16 allows the separation between at least the portion of the glass sheet 13 and the portion of the polycarbonate layer 16 that are in the vicinity of the impact area of the ballistic projectile. Similarly, when a ballistic projectile is shot at the interior side 4 of the unidirectional ballistic glass 10 (such as when a person shoots a gun at the interior side 4 of the unidirectional ballistic glass 10 from the interior space), the hydrophobic polymer layer 17 allows the separation between at least the portion of the polycarbonate layer 16 and the portion of the glass sheet 13 that are in the vicinity of the impact area of the ballistic projectile. So, once a ballistic projectile is shot at the interior side 4 of the unidirectional ballistic glass from the interior space (e.g., cockpit or passenger cabin), the adhesion may be eliminated between the polycarbonate 16 and the glass sheet 13.

As a result, the polycarbonate layer 16 is separated from the mass of the unidirectional ballistic glass 10, although it is moored to the same glass sheet 13 by the perimeter coating (e.g., polyurethane 18 and PVC 19). Having in mind that the polycarbonate layer 16 is not part of the mass of the unidirectional ballistic glass 10, it does not resist the impact of the ballistic projectile that enters the unidirectional ballistic glass 10 from the interior side 4, allowing the ballistic projectile to pass through the glass sheets 13, 12, and 11 (or glass sheets 13 and 11 when there are only two glass sheets), which are destroyed and traversed by the ballistic projectile. As illustrated in FIG. 1, the polyurethane layer 18 is disposed on the peripheral edges 13a and 16a, of the glass sheet 13 (i.e., interior glass sheet) and the polycarbonate layer 16, and the PVC layer 19 is disposed on a top side of the polyurethane layer 18 opposite from a side of the polyurethane layer 18 that is attached to the peripheral edges 13a and 16a of the glass sheet 13 (i.e., interior glass sheet) and the polycarbonate layer 16.

Although the impact of ballistic projectiles may eliminate adhesion between the polycarbonate layer 16 and glass sheet 13, the life cycle of the unidirectional ballistic glass 10 in relation to the delamination of the same unidirectional ballistic glass 10 may be extended. Even with the separate layers, moored by the perimeter coating (e.g., polyurethane 18 and PVC 19), the unidirectional ballistic glass 10 according to various embodiments has an optical quality of 100%.

In some embodiments, where the interior surface of the polycarbonate layer 16 is not coated with anti-scratch file, protecting coatings of polyurethane (with a thickness of 0.62 mm in one embodiment) and PVC may be coated on the interior surface of the polycarbonate layer 16.

FIGS. 2A and 2B illustrates different cross-sectional views of another unidirectional ballistic glass 10′ according to some embodiments of the present disclosure. In particular, FIG. 2A is a middle cross-sectional view of the unidirectional ballistic glass 10′, while FIG. 2B is a different cross-sectional view of the same unidirectional ballistic glass 10′ except that the cross-sectional view of FIG. 2B is a cross-sectional view near a peripheral edge (see broken lines A1-A2 in FIG. 2A showing the cross-sectional viewing perspective of FIG. 2B) of the unidirectional ballistic glass 10′.

As illustrated in FIGS. 2A and 2B, the unidirectional ballistic glass 10′ includes some of the same components/materials included in the unidirectional ballistic glass 10 of FIG. 1. For example, the unidirectional ballistic glass 10′ includes multiple glass sheets 11′, 12′, and 13′, a polycarbonate layer 16′ disposed on the interior side of the unidirectional ballistic glass 10′, a hydrophobic polymer layer 17′ disposed between the glass sheet 13′ and the polycarbonate layer 16′, and layers of polyurethane 18′ and PVC 19′ disposed along the peripheral edges 1la′ and 13′ of the various glass sheets 11′ and 13′, peripheral edges 16a′, 17a′, 21a′, and 22a′ of the polycarbonate layer 16′, the hydrophobic polymer layer 17, and adhesive intermediate layers 21′ and 22″, and peripheral edge[s] 20a′ of ballistic steel layer 20′ that is disposed on the peripheral edge[s] 12a″ of glass sheet 12′, encircling the glass sheet 12′. As further illustrated in FIG. 2A, the polyurethane layer 18′ is disposed on the peripheral edges 11a′, 13a′, 17a′, 16a′, 20a″, 21a′, and 22a′ of glass sheets 11′ and 13′, hydrophobic polymer layer 17′, polycarbonate layer 16′, ballistic steel layer 20′, and intermediate layers 21′ and 22′. The PVC layer 19′ is further disposed on top side of the polyurethane layer 18′ opposite from a side of the polyurethane layer 18′ that is attached to the peripheral edges 11a′, 13a′, 17a′, 16a′, 20a″, 21a′, and 22a′ of glass sheets 11′ and 13′, hydrophobic polymer layer 17′, polycarbonate layer 16′, ballistic steel layer 20′, and intermediate layers 21′ and 22′.

Note that similar to the embodiment illustrated in FIG. 1, glass sheet 11′ may be referred to as an exterior glass sheet since it is, among the three glass sheets illustrated in FIG. 2A, nearest to or at the exterior side 2 of the unidirectional ballistic glass 10′ while glass sheet 13′ may be referred to as an interior glass sheet since it is, among the three glass sheets, nearest to the interior side 4 of the unidirectional ballistic glass 10′. Glass sheet 12′, on the other hand, may be referred to as a middle glass sheet since it is disposed between the exterior glass sheet (e.g., glass sheet 11′) and the interior glass sheet (e.g., glass sheet 13′).

As noted above, the unidirectional ballistic glass 10′ includes reinforcing steel (ballistic steel layer 20′) disposed along the peripheral edge[s] 12a′ of the glass sheet 12′. Note that the incorporation of reinforcing steel in ballistic glass is a known technique (see, for example, U.S. Pat. No. 9,945,641, which is hereby incorporated by reference in its entirety). In some embodiments, the ballistic steel layer 20′ may have a thickness (t4) of between 2.5 mm and 6.25 mm, or between about 2.5 min and about 6.25 mm. One drawback in incorporating ballistic steel 20′ into the unidirectional ballistic glass 10′ is its tendency to separate from glass sheets 11′ and 13′ using conventional adhesive intermediate layers (such as adhesive intermediate layers 14 and 15 of FIG. 1) due to, among other reasons, the different thermal expansion rates of the steel and the adhesive intermediate layers. In order to avoid this problem, adhesive intermediate layers 21′ and 22′, may comprise of adhesive material[s] that is or are less rigid, than the adhesive material used in the adhesive intermediate layers 14 and 15 of FIG. 1. The adhesive intermediate layers 21′ and 22′ may comprise of one or more thermoplastic materials and may have a thickness (t5) of between 0.00015 mm and 7.56 mm, or between about 0.00015 mm and about 7.56 mm. In some embodiments, adhesive intermediate layers 21′ and 22′, as well as intermediate layers 14′ and 15′ of FIG. 1, may comprise of hydrophobic polymer that may be mixed with a thermoplastic material such as a monomer ionized or ionomer monomer. In some embodiments, the adhesive intermediate layers 21′ and 22″, which may comprise a thermoplastic material or materials, may include polyurethane or an ionomer monomer.

FIG. 3 is a cross-sectional view of another unidirectional ballistic glass 10″ according to some embodiments of the present disclosure. As illustrated, the unidirectional ballistic glass 10″ includes some of the same components included in the unidirectional ballistic glasses 10 and 10′ of FIGS. 1, 2A, and 2B, but with some structural differences. For example, unidirectional ballistic glass 10″ includes glass sheets 11″, 12″, and 13″ (with peripheral edges 1la″, 12a″, and 13a″), adhesive intermediate layer 15″ (with peripheral edge 15a″), polycarbonate layer 16″ (with peripheral edge 16a″), hydrophobic layer 17″ (with peripheral edge 17a″), polyurethane layer 18″, PVC layer 19″, ballistic steel 20″ (with peripheral edge 20a″), and intermediate layer 21″ (with peripheral edge 21a″), similar to or the same as the unidirectional ballistic glass 10′ or 10′ of FIGS. 1 or 2A, and 2B. However, the layers of polyurethane 18″ and the PVC 19″ are disposed only along the peripheral edges 16a″, 17a″, 13a″, and 15a″ of the polycarbonate layer 16″, the hydrophobic polymer layer 17″, the glass sheet 13″, and the adhesive intermediate layer 15″. Further, there is a height difference (or width differences depending on your perspective) between the glass sheet 11″ and the “top” of the PVC 19″, which is referred to as an OFF-SET.

As further illustrated in FIG. 3, the polyurethane layer 18″ is disposed on the peripheral edges 16a″, 17a″, 13a″, and 15a″ of the polycarbonate layer 16″, the hydrophobic polymer layer 17″, the glass sheet 13″, and the adhesive intermediate layer 15″. The PFC layer 19″ is further disposed on top side of the polyurethane layer 18″ opposite from a side of the polyurethane layer 18″ that is attached to the peripheral edges 16a″, 17a″, 13a″, and 15a″ of the polycarbonate layer 16″, the hydrophobic polymer layer 17″, the glass sheet 13″, and the adhesive intermediate layer 15″.

Note that similar to the embodiments illustrated in FIGS. 1, 2A, and 2B, glass sheet 11″ may be referred to as an exterior glass sheet since it is, among the three glass sheets illustrated in FIG. 3, nearest to or at the exterior side 2 of the unidirectional ballistic glass 10″ while glass sheet 13″ may be referred to as an interior glass sheet since it is, among the three glass sheets, nearest to the interior side 4 of the unidirectional ballistic glass 10″. Glass sheet 12″, on the other hand, may be referred to as a middle glass sheet since it is disposed between the exterior glass sheet (e.g., glass sheet 11″) and the interior glass sheet (e.g., glass sheet 13″).

In various embodiments, glass sheet 11* (i.e., glass sheet 11, glass sheet 11′, or glass sheet 11″) of FIG. 1, 2A, 2B, or 3 may be a painting glass, which is glass with coloring. In various embodiments, one or more of glass sheet 11*, glass sheet 12* (i.e., glass sheet 12, glass sheet 12′, or glass sheet 12″), and glass sheet 13* (i.e., glass sheet 13, glass sheet 13′, or glass sheet 13″) of FIGS. 1, 2A, 2B, and 3 may be replaced at least partially by a sheet of carbon fiber, polyamide, stainless steel, high wear steel, or other ballistic material. Note that in various embodiments, each of the unidirectional ballistic glasses 10, 10′, and 10″ of FIGS. 1, 2A, 2B, and 3 may be curved.

In various embodiments, each of the unidirectional ballistic glasses 10, 10′, and 10″ described herein may be curved.

In various embodiments, the unidirectional ballistic glasses 10, 10′, and 10″ described herein may be particularly suitable for use as windows and/or windshields of automobiles and armored vehicles. That is, for use as fixed mounted glasses such as windshields and rear windows, as fixed or adjustable sides and/or doors windows.

Also, the unidirectional ballistic glasses 10, 10′, and 10″ described herein may be particularly suitable for ships and aircraft, as well as for any type of building.

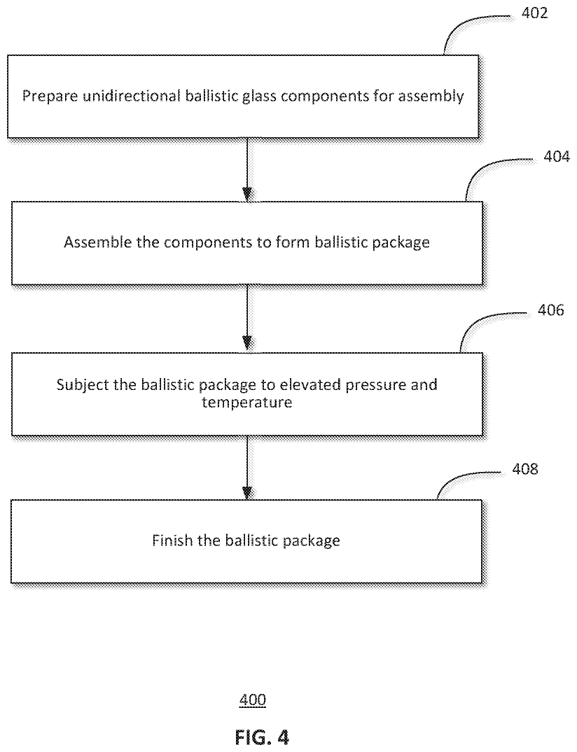

FIG. 4 shows a high-level process 400 for manufacturing a unidirectional ballistic glass, such as a unidirectional ballistic glass 10, 10′, or 10′ of FIG. 1, 2A, 2B, or 3C, in accordance with various embodiments. In some embodiments, the process 400 may begin at 402 when unidirectional ballistic glass components are prepared for assembly into a ballistic package. The ballistic glass components to be prepared may include, for example, a plurality of glass sheets and a polycarbonate layer, among other things. The preparation of the unidirectional ballistic glass components may include cutting of two or more glass sheets and a polycarbonate layer so that they have shapes that meet shape requirements for the unidirectional ballistic glass to be manufactured. For example, if the unidirectional ballistic glass to be produced is intended to be placed into the windshield slot or frame of an armored vehicle, then the two or more glass sheets and the polycarbonate layer are cut to ensure that the unidirectional ballistic glass that is manufactured will fit into the windshield slot or frame.

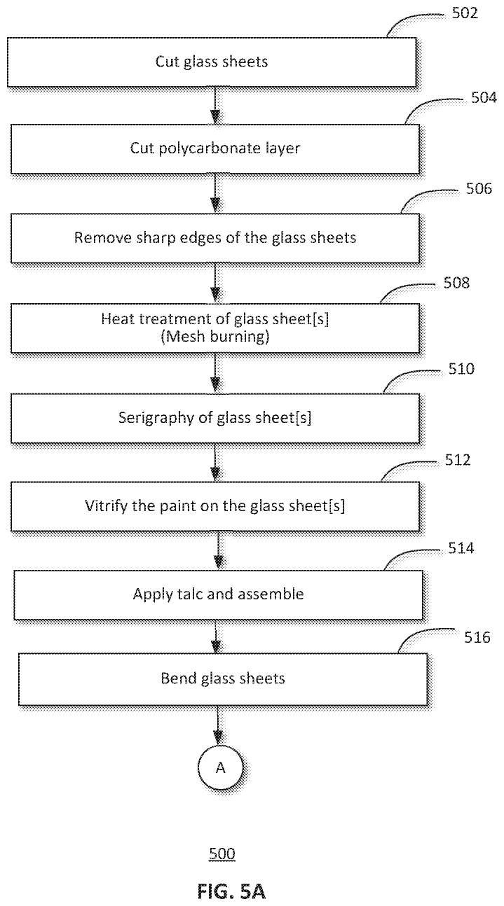

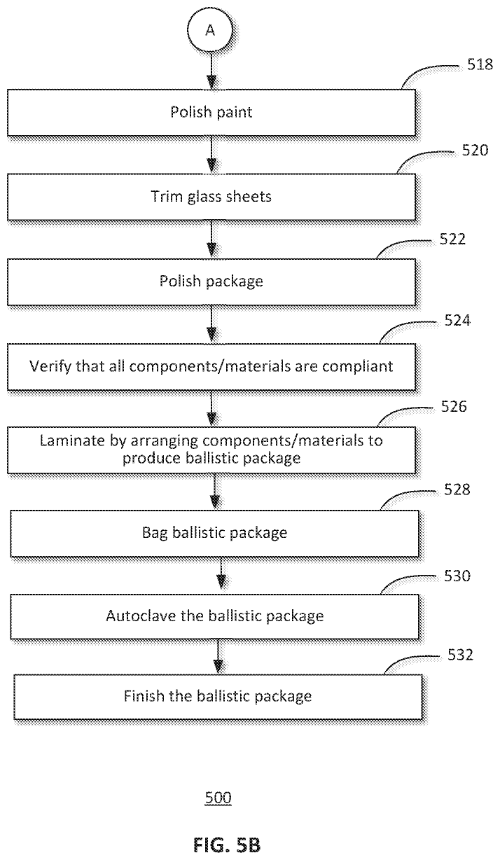

In various embodiments, operation 402 for preparing the unidirectional ballistic glass components may further involve one or more of removing sharp edges from the cut glass sheets, mesh burning operation of one or more of the glass sheets, paint printing (e.g., serigraphy) of one or more of the glass sheets, vitrifying the printed paint on the one or more glass sheets, applying talc to the surfaces of the glass sheets and organizing the glass sheets in the order that they will be placed in the unidirectional ballistic glass, bending the glass sheets, polishing the printed paint on the one or more glass sheets, trimming the glass sheets, polishing the package of glass sheets, and verifying that all of the unidirectional ballistic glass components (e.g., glass sheets, polycarbonate layer, hydrophobic polymer layer, adhesive thermoplastic material, polyurethane layer, PVC, and so forth) are compliant with the required measurements, optical quality, cleanliness and absence of spots, scratches, or streaks. Note that information regarding the above operations (e.g., cutting glass sheets and polycarbonate layer, removing char edges, and so forth) associated with the component preparation operation 402 are provide in greater detail below with reference to operations 502 to 524 of process 500 of FIGS. 5A and 5B. That is, the above-described operations mirror operations 502 to 524 of FIGS. 5A and 5B.

At 404, the unidirectional ballistic glass components are assembled and arranged in a particular order and orientation (e.g., final arrangement) that the components will be in when the finished unidirectional ballistic glass is produced through process 400. For example, if a three-glass sheet unidirectional ballistic glass is to be manufactured, such as one of the unidirectional ballistic glasses illustrated in FIG. 1, 2A, 2B, or 3, then three glass sheets may be stacked together with adhesive intermediate layers (e.g., adhesive thermoplastic material) placed between the glass sheets.

The three stacked glass sheets (e.g., glass sheets 11″, 12″, and 13″ of FIG. 3) include two outer glass sheets (e.g., glass sheets 11″ and 13″), and a middle glass sheet (e.g., glass sheet 12″) that is disposed between the two outer glass sheets, where one of the outer glass sheets is an exterior glass sheet (i.e., the glass sheet that will be, among the glass sheets, nearest to or at the exterior side of the unidirectional ballistic glass to be produced such as glass sheet 11″) and the other outer glass sheets is an interior glass sheet (i.e., the glass sheet that will be, among the glass sheets, nearest to the interior side of the unidirectional ballistic glass to be produced such as glass sheet 13″). The exterior glass sheet (e.g., glass sheet 11″), in various embodiments may be a printed glass sheet. Placed between the interior glass sheet (e.g., glass sheet 13″) and a polycarbonate layer (e.g., polycarbonate layer 16″) is a hydrophobic polymer layer (e.g., hydrophobic polymer layer 17″).

A layer of polyurethane (e.g., polyurethane 18″) and a layer of PVC (e.g., PVC 19″) may be placed or disposed on the perimeter or peripheral edges of at least the interior glass sheet (e.g., glass sheet 13″), the adhesive intermediate layer (e.g., adhesive intermediate layer 15″) between the interior glass sheet (e.g., glass sheet 13″) and the middle glass sheet (glass sheet 12″), the polycarbonate layer (e.g., polycarbonate layer 16″), and the hydrophobic polymer layer (e.g., hydrophobic polymer layer 17″).

In various embodiments, the lamination operation may be performed at a temperature between 19° C. and 23° C., or between about 19° C. and about 23° C., in a dry environment, between 25% and 35% of relative humidity, or between about 25% and about 35% of relative humidity. Note that in some embodiments, a ballistic steal layer (e.g., ballistic steel 20″) may be placed along the peripheral edge or edges of the middle glass sheet (e.g., glass sheet 12″). After assembling and arranging the various components in the proper order and orientation as described above, the assembled components forms a ballistic package. Note that operation 404 generally mirrors operation 526 of FIG. 5B.

At 406 the ballistic package is subject to elevated pressure and temperature to increase hardness and to avoid delamination. In various embodiments, the ballistic package may be placed in an autoclave to subject the ballistic package to the elevated pressure and temperature. More details regarding this operation may be found below with reference to operation 530 of FIG. 5B. That is, operation 406 mirrors operation 520 of FIG. 5B. Although not illustrated in FIG. 4, in some embodiments, the ballistic package may be bagged prior to operation 406 in order to place the ballistic package in a vacuum environment to draw out air trapped between the different layers of the ballistic package. Note that such a bagging operation is described below with respect to operation 528 of FIG. 5B.

At 408, the ballistic package is finished by verifying the functionality of the ballistic package (e.g., unidirectional ballistic glass), removing burrs that remain after the autoclaving operation, and/or polishing the edges of the ballistic package (e.g., the resulting unidirectional ballistic glass). As will be further illustrated, operation 408 mirrors operation 532 of FIG. 5B.

FIGS. 5A and 5B illustrate a more detailed process 500 for manufacturing a unidirectional ballistic glass, such as the unidirectional ballistic glass 10, 10′, or 10″ of FIG. 1, 2A, 2B, or 3, in accordance with various embodiments. Note that, after reviewing the present disclosure, those of ordinary skill in the art will recognize that process 500 includes using some well-known manufacturing operations, so the particularities and details of those well-known operations will not be described in detail herein. Note further that in various alternative embodiments, one or more of the operations illustrated in FIGS. 5A, 5B, and 5C may be omitted, and/or may be performed in an order different from the order depicted n FIGS. 5A, 5B, and 5C.

In various embodiments, process 500 may begin at 502 when two or more glass sheets to be incorporated into a unidirectional ballistic glass are cut according to the required shape for its intended purpose (e.g., to be part of a unidirectional ballistic glass that will be employed as a windshield/window of a particular model/type of automobile or aircraft) and to ensure that the perimeter of the glass sheets matches with, for example, the window/windshield slot that the unidirectional ballistic glass will be inserted into. At 504, a polycarbonate layer is cut according to the required shape for its intended purpose (e.g., to be part of a unidirectional ballistic glass that will be employed as a windshield/window of a particular model/type of automobile or aircraft) similar to the cutting of the glass sheets. In some embodiments, after cutting the polycarbonate layer, the cut polycarbonate layer should have a shape or outline that mirrors the shape or outline of the cut glass sheets.

At 506 the sharp edges of the glass sheets are removed. That is, after the cutting operation, sharp edges typically remain along the edges of the glass sheets, which may make further processing/manipulation of the glass sheets dangerous. In various embodiments, the edges of the glasses may be polished with a polisher or a machine that does it.

At 508, a mesh burning operation is perform where one or more of the glass sheets undergo heat treatment at a temperature between 40° C. and 80° C., preferably from 50° C. to 70° C., and more preferably between 55° C. and 65° C., for a period between 1 and 25 minutes, preferably between 2 and 25 minutes, and more preferably between 3 and 10 minutes. This is the stage in which the mimicry of the glass is made, every time it gives you color.

At 510, a serigraphy operation is performed on one or more of the glass sheets. In this operation the one or more glass sheets are printed with paint.

At 512, the paint printed onto the one or more glass sheets are vitrified. At this stage, the vitreous paint is fixed to the one or more glass sheets at a temperature between 250° C. and 570° C.

At 514, talc may be applied homogeneously on the surfaces of the glass sheets so that they do not melt together during a subsequent bending process and the glass sheets may be organized in the order that glass sheets will be in when the unidirectional ballistic glass is produced.

At 516, the glass sheets are bent (e.g., when a ballistic glass is used, for example, in a ground vehicle or an airplane, it often must be bent to be aerodynamically consistent with the outer frame/structure of the vehicle or airplane). The glass sheets are subjected to heat treatment at a temperature between 500° C. and 700° C., preferably between 520° C. and 680° C., more preferably between 540° C. and 660° C. In cases where the unidirectional ballistic glass to be produced is to be a replacement for, for example, a damaged ballistic glass of a vehicle, the glass sheets may be curved in a mold that has the same curvature of the original ballistic glass that the unidirectional ballistic glass is replacing, verifying that the paint on the painted glass sheets are maintained in the proper location. The bending of the glass sheets may make it easier for the resulting unidirectional ballistic glass to fit into, for example, the window or windshield slot or frame that the original ballistic glass was disposed in. Also, at this stage glass sheets may have an optical quality of 100%.

At 518, the paint printed on the one or more glass sheets are polished. At this stage, the measurements glass sheets may be rectified, the edges are polished if needed, assuring the perimeter and the curvature of the glass sheets.

At 520, the glass sheets are trimmed. In particular, the glass sheets are cut according to the size required to avoid generation of ballistic holes.

At 522, the package of glass sheets is polished. In situations where the resulting unidirectional ballistic glass is to be used to replace, for example, a damaged ballistic glass of an armored vehicle, the measures of the ballistic package are rectified so that the ballistic package perimeter coincides with the perimeter of the original ballistic glass.

At 524, a pre-laminate operation is performed where all the materials/components to be used to produce the unidirectional ballistic glass may be verified as being compliant with the required measurements, optical quality, cleanliness and absence of spots, scratches, or streaks.

At 526, a lamination operation is performed on the assembled components/materials of the unidirectional ballistic glass to be produced. To laminate, all of the unidirectional ballistic glass components/materials that have been prepared for assembly may be arranged and organized in the pre-established order (glass sheets, thermo-sensitive polymers, polycarbonates, etc.), including the hydrophobic material between the polycarbonate and glass layers, according to the desired ballistic level. In other words, arranging the unidirectional ballistic glass components into a final arrangement that the components will be in when the unidirectional ballistic glass is produced by process 500. For example, if a three-glass sheet unidirectional ballistic glass is to be manufactured, such as one of the unidirectional ballistic glasses illustrated in FIG. 1, 2A, 2B, or 3, then three glass sheets may be stacked together with adhesive intermediate layers (e.g., adhesive thermoplastic material) placed between the glass sheets.

The three stacked glass sheets (e.g., glass sheets 11″, 12″, and 13″ of FIG. 3) include two outer glass sheets (e.g., glass sheets 11″ and 13″), and a middle glass sheet (e.g., glass sheet 12″) that is disposed between the two outer glass sheets, where one of the outer glass sheets is an exterior glass sheet (i.e., the glass sheet that will be at or nearest to the exterior side of the unidirectional ballistic glass to be produced such as glass sheet 11″) and the other outer glass sheets is an interior glass sheet (i.e., the glass sheet that will be nearest to interior side of the unidirectional ballistic glass to be to be produced such as glass sheet 13″). The exterior glass sheet (e.g., glass sheet 11″), in various embodiments may be a printed glass sheet. Placed between the interior glass sheet (e.g., glass sheet 13″) and a polycarbonate layer (e.g., polycarbonate layer 16″) is a hydrophobic polymer layer (e.g., hydrophobic polymer layer 17″).

A layer of polyurethane (e.g., polyurethane 18″) and a layer of PVC (e.g., PVC 19″) may be placed on the perimeter or peripheral edges of at least the interior glass sheet (e.g., glass sheet 13″), the adhesive intermediate layer (e.g., adhesive intermediate layer 15″) between the interior glass sheet (e.g., glass sheet 13″) and the middle glass sheet (glass sheet 12″), the polycarbonate layer (e.g., polycarbonate layer 16″), and the hydrophobic polymer layer (e.g., hydrophobic polymer layer 17″).

In various embodiments, the lamination operation may be performed at a temperature between 19° C. and 23° C., in a dry environment, between 25 and 35% of relative humidity. Note that in some embodiments, a ballistic steal layer may be placed along the peripheral edge or edges of the middle glass sheet. After assembling and arranging the various components in the proper order and orientation as described above, the assembled components forms a ballistic package.

At 528, the ballistic package is bagged. In particular, the ballistic package is placed inside a bag, a vacuum environment in the bag is generated so that any air present between the different layers/materials of the ballistic package is drawn out or removed.

At 530, the ballistic package is placed into an autoclave. While in the autoclave, the autoclave may be subjected to a pressure in a range between 50 PSI and 250 PSI, preferably between 70 PSI and 230 PSI, and more preferably between 100 PSI and 200 PSI, at a temperature between 50° C. and 200° C., preferably between 60° C. and 190° C., and more preferably between 70° C. and 180° C. This stage may result in a longer life cycle for the resulting unidirectional ballistic glass that is produced, since it may result in a unidirectional ballistic glass with greater hardness and that avoids delamination.

At 532, the ballistic package produced by the autoclave operation 530 may be finished. This may entail the functionality of the unidirectional ballistic glass (e.g., the ballistic package) being verified, the removal of burrs that can remain after the autoclaving process, and/or polishing the edges of the resulting ballistic package (e.g., resulting unidirectional ballistic glass).

In one embodiment, after bagging (hot), is carried out the cold bagging stage, in which the bag with the ballistic package is held in vacuum between 20 minutes and 240 minutes, preferably between 30 minutes and 200 minutes. In some embodiments, when the ballistic package is placed in a vacuum bag, it may be kept cool to, among other things, ensure that air in the ballistic package is removed.

In one embodiment, after bagging, the pre-adhesion stage is carried out, in which the laminated set assembly is subjected to vacuum, for between 30 minutes and 240 minutes, at a temperature between 30° C. and 100° C., preferably between 40° C. and 90° C. At this stage is guaranteed that the curvature of the ballistic protection glass is homogeneous, so, those sheets that do not have the required curvature are destroyed.

In one embodiment, after the autoclave stage (e.g., operation 530) a second stage of autoclave may be carried out in which the laminated set (e.g., ballistic package) is subjected to a pressure in a range between 50 PSI and 250 PSI, preferably between 70 PSI and 230 PSI, more preferably between 100 PSI and 200 PSI, at a temperature between 50° C. and 200° C., preferably between 60° C. and 190° C., more preferably between 70° C. and 180° C.; this stage may homogenize the union between the different layers that make up the ballistic protection glass.

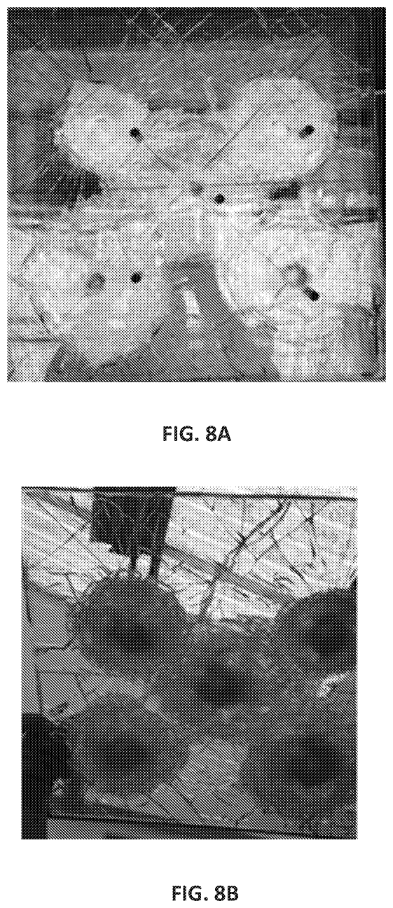

FIGS. 8A and 8B shows how the aggression of ammunition damages the appearance of the glass, although the glass withstands the shots, it is evident how the glass is destroyed.

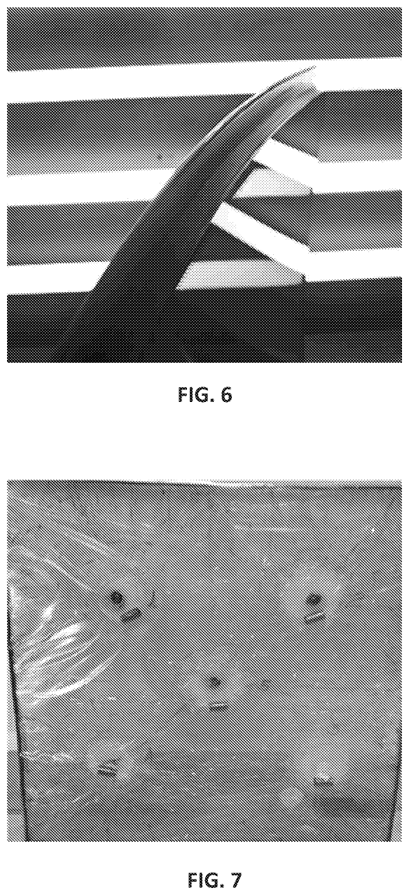

Once the composition has been developed, the autoclave process and the use of high-quality materials are able to maintain the optical appearance of the unidirectional ballistic glass according to the established parameters as shown in FIG. 6.

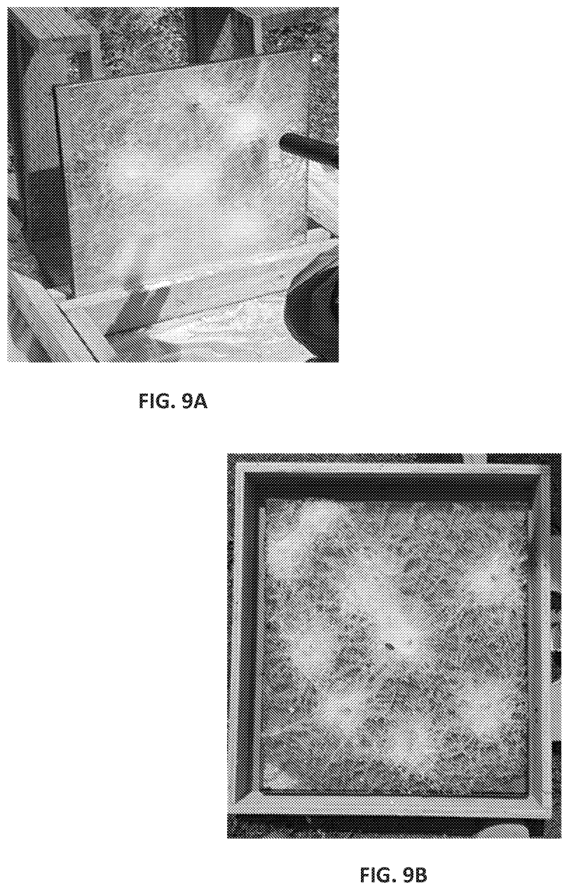

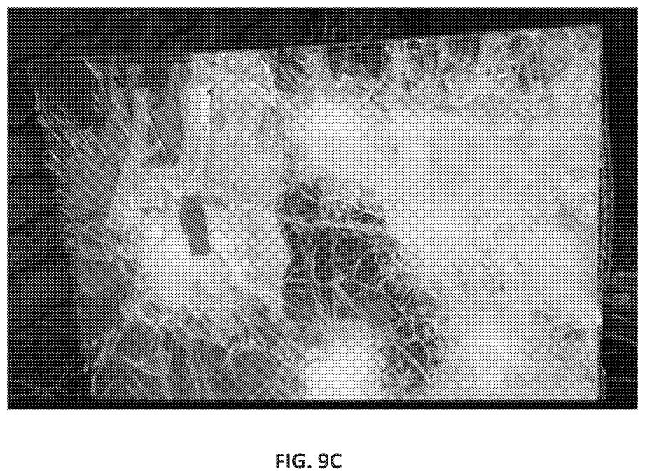

The increase of the ballistic resistance is mainly due to the correct management of the energy dispersion on the spring developed within the ballistic glass composition, as can be evidenced, as shown in FIGS. 9B and 9C, on the upper part of the sample unidirectional ballistic glass, which was able to withstand eight impacts in the 25% of their area when it only has to resist one shot by the standard.

A unidirectional ballistic glass, according to various embodiments, was tested. The objective of this test was to recreate a real attack condition where a dispersion was made according to the standard without any problem, but later a concentration of impacts was made on one of the ends of the sample with no single shot passing through the unidirectional ballistic glass. As shown in FIG. 7, the unidirectional ballistic glass sample that was used resisted impacts and additionally the damage diameter caused by each bullet did not exceed 60% of a classic glass. FIG. 7 shows how the unidirectional ballistic glass sample limits the impact to a diameter of less than 25 mm, which gives it greater visuality and guarantees that the unidirectional ballistic glass will continue to resist more impacts.

A test was conducted where a ballistic projectile was shot (e.g., a defensive shot) into the interior side of a unidirectional ballistic glass sample. FIG. 9A shows the result of the test, where the affected part is just the diameter of the ammunition used closing the impact step.

Provided in the following are actual examples of unidirectional ballistic glasses according to various embodiments, actual example of how unidirectional ballistic glasses were formed according to various embodiments, and actual examples of how unidirectional ballistic glasses performed when ballistic projectiles were fired at the unidirectional ballistic glasses according to various embodiments.

### Example 1

A reference of ballistic glass was developed, corresponding to a glass normally used in the safety sector, using the techniques commonly used. The resulting ballistic glass having, from exterior to interior, the following layers: glass 6 mm, polyvinyl butyral 2 mm, glass 6 mm, polyvinyl butyral 0.76 mm, 4 mm glass, polyurethane 1.92 mm, and polycarbonate 3 mm. The resulting unidirectional ballistic glass produced using this approach produced a unidirectional ballistic glass 10 as illustrated in FIG. 1.

### Example 2

A unidirectional ballistic glass was developed in accordance with some embodiments, the resulting unidirectional ballistic glass includes from outside to inside: glass 6 mm, ionomer 1.52 mm, glass 6 mm, ionomer 0.76 mm, glass 4 mm, hydrophobic polymer, 3 mm polycarbonate, where the perimeter or edge of the resulting unidirectional ballistic glass was coated with polyurethane and polyvinylchloride according FIG. 3.

### Example 3

The unidirectional ballistic glass of Example 2 was prepared with the following procedure:

The glass sheets were cut according to the required shape (e.g., the shape that the unidirectional ballistic glass needs to have for its intended purpose—to fit the window frame or slot of a particular vehicle).

The polycarbonate was cut according to the required shape.

The glass sheets were polished eliminating the sharp edges, the measures were also adjusted.

The meshes were burned by a heat treatment of 75° C. for 10 minutes.

Vitreous paint was fixed to the glass sheet, it was done at a temperature of 300° C.

Powder was applied homogeneously on the surface of all the glass sheets in order to avoid melting between sheets in the bending process and were organized in the proper order in the ballistic glass.

The glass sheets were subjected to bending, by a heat treatment at a temperature of 600° C. The glass sheets are curved on a pre-prepared mold.

The painting remained.

The paint was polished, measures were rectified, and the edges were polished.

The glass was cut according to the required size.

The measures of the ballistic package were rectified.

Once verified that all the materials comply with the characteristics of measurements, optical quality, cleanliness and absence of spots, scratches, or streaks, all the sheets of the materials were accommodated in the pre-established order, including the hydrophobic material between the polycarbonate and glass.

The laminated set was put inside a bag.

The laminated set was in vacuum process for 180 minutes.

In a vacuum environment, the set was exposed to a temperature of 45° C. for 120 minutes.

The laminated set was introduced into the autoclave, under a pressure of 180 PSI and a temperature of 160° C.

The burrs that were left from the autoclave process were removed and the edges of the product were polished.

The glass of Example 2, and that was obtained according to Example 3, does not have opacity, does not present distortion of light, and has optical purity as can see in FIG. 6.

### Example 4

Five shots were fired with a Smith and Wesson 9 mm gun using ammunition 9 mm. WCC NATO to 6 m distance from the samples of the ballistic protection glass of Example 2, elaborated by using the process on Example 3. The diameter of the area affected by the impacts is 2.5 cm, as shown in FIG. 7. The same test was also performed on the ballistic protection glass sample in accordance with Example 1. The diameter of the area affected by the impacts was 8 cm, as evidenced in FIGS. 8A and 8B. Thus, the area affected by the impacts on the ballistic glass according to various embodiments corresponds to 60% of the area affected by the impacts on the standard ballistic glass.

### Example 5

With a 9 mm projectile WCC NATO, shots were fired at 10 cm, from the ballistic glass sample of Example 2, elaborated by using the process of Example 3, from the face projected towards the cockpit. The projectile pass through the ballistic glass as shown in FIG. 9A. Likewise, the same test was performed on the ballistic glass of Example 1. The projectile did not pass through the ballistic glass as found in FIGS. 9B and 9C.

### Example 6

Eight shots were fired with a Smith and Wesson 9 mm gun with ammunition 9 mm WCC NATO from 6 m distance from the samples of the unidirectional ballistic glass of Example 2, elaborated by using the process of Example 3. The glass resists all the impacts, as found in FIG. 9C, when it supposed to resist only one shot. Likewise, the same test was performed on the ballistic glass sample in accordance with Example 1, however, the glass was destroyed, as evidenced in FIGS. 8A and 8B.

The figures presented in this description correspond to purely illustrative purposes of the invention. It is implied that the figures described do not limit the scope of the disclosed invention. A person versed in art is able to conceive modifications after the principles determined in this document.

The various embodiments described herein, are presented as non-limiting example embodiments of the present disclosure, unless otherwise expressly indicated. After reviewing the present disclosure, an individual of ordinary skill in the art will immediately appreciate that some details and features can be added, removed and/or changed without deviating from the spirit of the disclosure. Reference throughout this specification to “various embodiments,” “one embodiment,” “an embodiment,” “additional embodiments)”, “alternative embodiments,” or “some embodiments,” means that a particular feature, structure, or characteristic described in connection with the embodiment(s) is included in at least one or some embodiment(s), but not necessarily all embodiments, such that the references do not necessarily refer to the same embodiment(s). Furthermore, the particular features, structures, or characteristics may be combined in any suitable manner in one or more embodiments. These and other changes can be made to the embodiments in light of the above-detailed description. In general, in the following claims, the terms used should not be construed to limit the claims to the specific embodiments disclosed in the specification but should be construed to include all possible embodiments along with the full scope of equivalents to which such claims are entitled. Accordingly, the claims are not limited by the disclosure.

What is claimed is:

1. A unidirectional ballistic glass for defending against simultaneous multi-shot attack, comprising:
an exterior side and an interior side opposite from the exterior side;
a plurality of glass sheets attached to each other by one or more adhesive intermediate layers, the plurality of glass sheets including an exterior glass sheet that is, among the plurality of glass sheets, nearest to or at the exterior side of the unidirectional ballistic glass, and an interior glass sheet that is, among the plurality of glass sheets, nearest to the interior side of the unidirectional ballistic glass;
a hydrophobic polymer layer disposed between a polycarbonate layer and the interior glass sheet; and
a polyurethane layer and a polyvinyl chloride (PVC) layer that are disposed on peripheral edges of at least the interior glass sheet and the polycarbonate layer.

2. The unidirectional ballistic glass of claim 1, wherein the one or more adhesive intermediate layers include a mixture of an ionomer monomer and a hydrophobic polymer.

3. The unidirectional ballistic glass of claim 1, wherein the one or more adhesive intermediate layers include a thermoplastic material that includes at least one of polyvinyl butyral, polyvinyl acetal, polyurethane, or a combination thereof.

4. The unidirectional ballistic glass of claim 1, wherein the one or more adhesive intermediate layers include an ionomer monomer and a material selected from one of polyvinyl butyral, polyvinyl acetal, or polyurethane.

5. The unidirectional ballistic glass of claim 1, wherein the plurality of glass sheets includes one or more glass sheets that include at least one of floated glass, borosilicate glass, sodium-calcium glass, lead glass, silica glass, or painting glass.

6. The unidirectional ballistic glass of claim 1, wherein the plurality of glass sheets includes a middle glass sheet disposed between the exterior glass sheet and the interior glass sheet, the middle glass sheet being attached to the exterior glass sheet and the interior glass sheet with adhesive intermediate layers.

7. The unidirectional ballistic glass of claim 6, wherein the polyurethane layer and the PVC layers are further disposed on peripheral edges of at least the exterior glass sheet and the middle glass sheet.

8. The unidirectional ballistic glass of claim 6, further comprising a ballistic steel layer disposed along peripheral edge or edges of the middle glass sheet.

9. The unidirectional ballistic glass of claim 8, wherein the ballistic steel layer is attached to the exterior glass sheet and the interior glass sheet with the adhesive intermediate layers.

10. The unidirectional ballistic glass of claim 8, wherein the adhesive intermediate layers comprise of polyurethane or ionomer monomer.

11. The unidirectional ballistic glass of claim 1, wherein an anti-scratch film is disposed on a surface of the polycarbonate layer that is opposite from another surface of the polycarbonate layer that faces the hydrophobic polymer layer.

12. The unidirectional ballistic glass of claim 11 wherein the anti-scratch film is attached to the polycarbonate layer by an intermediate layer of thermoplastic.

13. The unidirectional ballistic glass of claim 1, wherein the polyurethane layer is disposed on the peripheral edges of the interior glass sheet and the polycarbonate layer, and the PVC layer is disposed on a top side of the polyurethane layer opposite from a side of the polyurethane layer that is attached to the peripheral edges of the interior glass sheet and the polycarbonate layer.

14. The unidirectional ballistic glass of claim 1, wherein the unidirectional ballistic glass is curved.

15. A unidirectional ballistic glass, comprising:
an exterior side and an interior side opposite from the exterior side;
a plurality of glass sheets attached to each other by adhesive intermediate layers, the plurality of glass sheets including an exterior glass sheet that is, among the plurality of glass sheets, nearest to or at the exterior side of the unidirectional ballistic glass and an interior glass sheet that is, among the plurality of glass sheets, nearest to the interior side of the unidirectional ballistic glass, and a middle glass sheet disposed between the exterior glass sheet and the interior glass sheet;
a ballistic steel layer disposed along peripheral edge or edges of the middle glass sheet and attached to the exterior glass sheet and the interior glass sheet by the adhesive intermediate layers; and
a hydrophobic polymer layer disposed between a polycarbonate layer and the interior glass sheet.

16. The unidirectional ballistic glass of claim 15, wherein the adhesive intermediate layers include a mixture of an ionomer monomer and a hydrophobic polymer.

17. The unidirectional ballistic glass of claim 15, further comprising a polyurethane layer and a polyvinyl chloride (PVC) layer that are disposed on peripheral edges of at least the interior glass sheet and the polycarbonate layer.

18. The unidirectional ballistic glass of claim 17, wherein the polyurethane layer and the PVC layer are disposed on peripheral edges of each of the ballistic steel layer, the middle glass sheet, and the exterior glass sheet.

19. The unidirectional ballistic glass of claim 17, wherein the PVC layer is disposed on a top side of the polyurethane layer opposite from a side of the polyurethane layer that is attached to the peripheral edges of the interior glass sheet and the polycarbonate layer.

20. The unidirectional ballistic glass of claim 15, wherein the polyurethane layer and the PVC layer are disposed on the peripheral edges of the ballistic steel layer and the exterior glass sheet.
